(19) United States
(12) Patent Application Publication
(10) Pub. No.: US 2006/0261214 A1
(43) Pub. Date: Nov. 23, 2006

(54) Method and device for steering system adjustment and steering system of wheels of a vehicle having knuckle steering system

(76) Inventors: Stefan Wallner, Friedrichshafen (DE); Klaus Kruber, Kunzing (DE)

Correspondence Address: DAVIS & BUJOLD, P.L.L.C., 112 PLEASANT STREET, CONCORD, NH, 03301, US

(21) Appl. No.: 11/436,221

(22) Filed: May 18, 2006

(30) Foreign Application Priority Data
May 20, 2005 (DE) 102005023286.8

(51) Int. Cl. B64C 25/50

(52) U.S. Cl. 244/50

(57) ABSTRACT

A method for a steering system adjustment and a steering system of articulated wheels of a vehicle having a knuckle steering system by which, both in a four-wheel and a two-wheel steering mode and preferably also in any desired intermediate modes, the Ackermann angle and optionally a desired steering angular deflection can be respectively adjusted, preventing the former disadvantages resulting from a rigid localization of an Ackermann intersection point. The method improves the total driving behavior of the vehicle and reduces the wear detectable on tires and chassis sites. The method for steering system adjustment and/or for steering system of the wheels provides that an Ackermann intersection point is moved by an operator or a selector and control device along a vehicle longitudinal axis and/or the extension thereof within an area determined by the maximum steering angle of the wheel axles.

This application claims priority from German Application Serial No. 10 2005 023 286.8 filed May 20, 2005.

### FIELD OF THE INVENTION

The invention relates respectively to a method and device for a steering system adjustment and a steering system of wheels of a vehicle having a knuckle steering system and a plurality of steerable axles.

### BACKGROUND OF THE INVENTION

It is generally known that wheel vehicles can be steered according to four basically different principles. In the so-called articulated steering system, the wheels of the vehicle cannot be displaced relative to the vehicle parts that carry them. A joint point is provided approximately in the center of the vehicle, around which the front vehicle can be displaced towards the rear vehicle. The system stands out by very small possible turns and has proved useful for certain construction site vehicles, such as wheel loaders. The basic structure of the vehicle, however, has to be tuned entirely to said type of steering system. Besides, it is in general only poorly suitable for high vehicle speeds, therefore it has come to be used only for certain special vehicles.

It is further known individually to drive the wheels at desired rotational speeds thus imitating the driving characteristics of track laying vehicles. But this kind of steering system requires great expenditure for wheels individually actuatable according to direction of rotation and rotational speed, leading to strong sliding motions of the contact surfaces of the tire on the soil and thus to intensive wear of the tires. This kind of steering system also leads to an unstable behavior at high vehicle speeds and is accordingly limited in its application.

Vehicles with articulated wheels are steered according to the principle of knuckle steering or of rotational compensation steering. In the rotational compensation steering system known since olden times, the steered wheels of one axle are rotated by a displacement of the whole axle around a rotation point to the height of the longitudinal axis of the vehicle. This kind of steering system is to be specially found in two-axle trailers and by virtue of the co-axiality of the wheel axles of the steered vehicle axis ensures in a structurally specially simple manner that the so-called Ackermann condition be met according to which the lengthened wheel axles of the vehicle axles have to meet at one point so as to prevent sliding of the wheels upon the ground. In the case of a vehicle having one rear axle not steered and one front axle steered, according to the rotation compensation principle, this point is the intersection point of the extension of the rear axles with the extension of the wheel axles of the front axle. This clearly means that all wheels describe a circular path around the intersection point. The wear of the tires and the forces on the wheel suspension are accordingly small.

To move the whole axle toward the longitudinal axis of the vehicle for sharp steering angles, the rotation compensation steering system, of course, needs a large installation space. In addition, the contact point of the wheels on the ground shifts strongly in direction to the longitudinal axis of the vehicle from which a considerable tendency to tipping can result. Due to the aggravating disadvantages, the rotation compensation steering in actively steered vehicles can be used only sporadically.

As a single-wheel steering system, the knuckle steering system is not advised for deviation of the entire steered vehicle axle, requiring therefore, compared to the rotation compensation steering system, a small installation space and stands out by a small inclination to tipping in case of sharp steering angles. But bear in mind that when cornering the steering angle of the internal curve of the wheel, compared to the vehicle longitudinal axis, has to be larger than the steering angle of the external curve of the wheel so as to make a rotation around a common point possible according to the Ackermann condition. Since the first days of the automobile, this had been accomplished by mechanical devices such as are covered by German Patent No. DE-73515. At the same time, the concept of the wheels of a vehicle axle in this kind of steering system is not linked to a continuously physically existing axis, but in particular serves in single-wheel suspensions to designate wheels; the axles of which in straight out position intersect the longitudinal axis of the vehicle approximately at one point and at a right angle.

The Ackermann angle, that is, the angular deviation from each other of the axles of the steered wheels of an axle, which makes rolling possible with a slight wear of the wheels around a common point of the center of the curve, can be easily adjusted with at least sufficient precision for vehicles having one steered and one not steered axle by flexibly connected rigid devices. To adjust the Ackermann angle for such a vehicle, the point at which the extensions of the axles of all wheels intersect must necessarily lie on a straight line defined by the rear vehicle axle or the axles of the rear wheels.

For the sake of simplicity, the point at which the extensions of the axles of all wheels meet to comply with the Ackermann condition is to be designated as an Ackermann point, while a straight line which cuts the vehicle longitudinal axis at right angle and leads through the Ackermann point is defined as an Ackermann straight line. The point at which the Ackermann straight line and the vehicle longitudinal axis or the extension thereof intersect at right angle is designated herebelow as an Ackermann intersection point.

A certain steering angle error, i.e., the deviation of the axles of the steered wheels of a vehicle axle from the Ackermann angle, is also often desired or absolutely needed to be able to achieve good driving properties such as a small turn and higher transverse forces between wheel and ground. For this reason, there will be used herebelow, the expression steering angle deviation, which means a desired steering angle deviation while the expression steering angle error is meant to be used for undesired steering angle deviations from the Ackermann angle.

The consequence of the steering angle deviation is that the extensions of the wheel axles no longer meet at an Ackermann point. However in these cases, the Ackermann point or Ackermann straight line also forms the reference parameter, since the steering angle deviation is really defined precisely as a deviation from the steering angle which would result when the Ackermann condition is exactly met.

In conventional steering devices consisting of elements of fixed lengths which are flexibly interconnected, the actual steering angle of the axle, taking into account the Ackermann condition and an eventually desired steering angle deviation in two or more steered axles, can be adjusted at reasonable expenditure only for an established Ackermann straight line or an established Ackermann intersection point. For a two-wheel steering mode, the Ackermann intersection point is at the level of the vehicle of the rear wheels when the rear wheels are fixed in straight alignment.

For a four-wheel steering mode, the Ackermann intersection point for optimal maneuverability of the vehicle, lies in the area of the midpoint between front axle and rear axle. This, of course, overcomes considerable disadvantages relative to the driving behavior in street traffic at high speeds.

For this reason, the steering geometry also for construction site vehicles with a four-wheel steering mode in part is not laid out on the four-wheel steering system preferably used in the construction site operation and on an optimal maneuverability, but for a two-wheel steering mode with rear wheel axles fixed in straight arrangement which, in the four-wheel steering mode, results in a considerable steering angle error and thereby in considerable sliding motion of the wheels on the ground and thus correspondingly strong wear of the tires.

In the Applicant's unpublished DE-10 2004 053 727 is described a knuckle steering device, having one main steering cylinder, which actuates a piston rod which acts respectively upon a left and right track rod and produces the angle of the coordinated wheel carrier. Additional kinematics are provided which, for its part, can produce a swiveling motion of the wheels relative to each other, a motion of the piston rod by the main steering cylinder and by the added steering kinematics being superimposed so that the resulting steering angle error is minimal. It is possible for this to design of variable length the effective track rod lengths and/or the effective length of the piston rod or of the partial piston rods of a divided piston rod. The length can be changed, for example, by a telescopic hydraulic cylinder or by way of threaded spindles.

This device can be provided for a front axle, for a rear axle or for a vehicle having at least two steerable axles. Nothing has been said relative to a control or generally to the behavior of such a device in a vehicle with a four-wheel steering mode.

For the sake of completeness, let it be mentioned that it is also obviously possible to deflect the wheels of an axle by actuators controllable with absolute independence of each other. Since in this special case at any rate rarely implemented, the behavior of a knuckle steering system is imitated, there is to be included within the scope of this application, likewise under the expression of the knuckle steering system, a steering system by actuators operative only for one wheel.

It must finally be made clear that the expression “one wheel” in the scope of this publication must be understood in the sense of “one wheel or several wheels of the same side of the vehicle and vehicle axle” and it is obviously not to be excluded that instead of the wheel, for example, a twin tire or also two tires can be assembled.

It can altogether be maintained that even though the steering system arrangements and steering methods of the prior art are capable of adjusting satisfactorily, the Ackermann angle for a four-wheel steering mode or for a two-wheel steering mode and, at the same time, also implementing, when needed, a desired steering angle deviation of the wheel axles. Until now, a fixed Ackermann intersection point has always been used whereby the optimization of both steering system kinds, in the sense of shifting of the Ackermann intersection point between both in the current operation or quite in the sense of a continuous adjustment, has not been known thus far.

An addition consisting in limiting the steering angle of the wheels of an axle at high vehicle speeds may, at the cost of maneuverability of the vehicle, produce a certain improvement in driving safety and limitation of tire wear at said speeds, but does not solve the basic problem of a steering system ultimately optimized only for a steering mode and based on an established Ackermann intersection point.

Another addition of designing the steering system based neither on a pure two-wheel steering mode with an Ackermann intersection point at the level of the not steered axle nor on a four-wheel mode with optimal maneuverability and one Ackermann intersection point approximately on the middle point between the axles, but to establish the Ackermann intersection point, for example, at 70%, 80% or 90% of the track between the front axle and the rear axle, likewise is not much of a solution to the problem, only distributing the disadvantages at different ratios between both steering modes.

With this background, the problem on which the invention is based is to propose a method and a device for steering articulated wheels of a vehicle, having a knuckle steering system by which both in a four-wheel steering mode and in a two-wheel steering mode and preferably also in any intermediate modes and in steering modes having more than two articulated axles, the Ackermann angle and optionally a desired steering angle deviation can respectively be adjusted preventing the former disadvantages that result from the rigid establishment of the Ackermann intersection point. The method is to improve the whole driving characteristics of the vehicle and detectably to reduce the wear on the tires and chassis parts. Finally, by preventing forced sliding motions of the wheels upon the ground, the fuel consumption and noise emission of the vehicle are positively controlled.

### SUMMARY OF THE INVENTION

The invention is based on the knowledge that the stated problem can be solved by the fact that the intersection point of the Ackermann straight line is made adjustable with the longitudinal axis of the vehicle along the longitudinal axis and optionally the extension thereof.

Accordingly, the invention relates in the first place to a method for steering system adjustment and steering system of wheels of a vehicle having knuckle steering system, the same as a plurality of steerable vehicle actuators of steering devices are operated by way of which the wheels are adjusted to the steering angle taking into account the vehicle steering system, all extensions of the axles of the wheels, for approximately arbitrary steering angle meeting approximately at an Ackermann point at which the extensions of the axles of all wheels intersect to meet the Ackermann condition.

By the term “approximately arbitrary steering angle” is to be understood here that at least for the predominant areas of the possible steering angles, the extension of the wheel axles have to meet at one Ackermann point. But for extreme steering angles, a wheel axle inside the curve, for example, often hits before a wheel axle outside the curve at the limit of its physical adjustability. To implement a still smaller turn, it is conceivable that the remaining wheels at any rate can be further impacted even though this results in non-compliance with the Ackermann condition. Certain special functions are also conceivable which, in special dangerous situations, for example, adjust individual wheels of the vehicle so that sliding of the wheel over the ground is purposefully produced. Vehicles or steering methods which assist such special function, but in predominant operation time extensively adjust the wheel axles so as to meet the Ackermann condition (optionally taking into account a steering angle deviation).

The term “steering angles meet at an Ackermann point at least approximately” is to be understood in the sense that for improving the driving behavior a certain steering angle deviation often is purposefully produced or that due to mechanical marginal conditions a certain small steering angle error cannot be prevented. Both the ideas of the steering angle error and of the steering angle deviation—as already explained above—are defined as deviation of the angle of the wheel axle from the Ackermann angle and, therefore, necessarily imply an Ackermann point and thus also an Ackermann straight line, the same as an Ackermann intersection point, as reference values. Vehicles or steering methods which purposefully produce the adjustment of a steering angle deviation or knowingly allow for a steering angle error are, therefore, ultimately based always on a method that departs from extensions of the wheel axles meeting in an Ackermann point.

To solve the stated problem, the invention provides regarding the method that the steering system adjustment or the steering system of the wheels be adjusted by an operator or a selector and control device in a manner such that an Ackermann intersection point is pushed along the vehicle longitudinal axis and/or the extension thereof within an area determined by the maximum steering angle of the wheel axles; there being designated as an Ackermann intersection point, the point at which the vehicle longitudinal axis or the extension thereof and an Ackermann straight line intersect at right angle and the Ackermann straight line being the straight line which cuts the vehicle longitudinal axis at right angle and leads through the Ackermann point.

By this method, simple only in appearance, which for its implementation ultimately presupposes either an expensive single-wheel steering system with wheel axles adjustable independently of each other and corresponding actuators or a device, such as disclosed in DE-10 2004 053 727, it is possible to regulate and/or control the steering behavior of the vehicle according to the stated problem. Thereby can be ensured that sliding motions of the wheels upon the ground be extensively prevented and, at the same time, the intersection point of the Ackermann straight line with the vehicle longitudinal axis can be freely selected within certain limits so that this intersection point is not established as in the prior art upon one or at most a few defined position.

The Ackermann intersection point can lie in the midpoint between a front vehicle axle and a rear vehicle axle to achieve optimal maneuverability. Thus the steering behavior of a previously described four-wheel steering system with optimal maneuverability would result, but also with the above described disadvantages regarding the driving behavior at high vehicle speeds.

The essential advantage of this method is now that not only can this specific point be selected, but that the Ackermann intersection point can be freely adjusted to a great extent. The nearer it moves to the rear vehicle axle, the more the driving behavior of a classic knuckle front axle steering system results. When the Ackermann intersection point is in the area of the front vehicle axle, the driving behavior of a rear-axle steering system results and the nearer the intersection point is to the midpoint between the axles, the stronger the steering behavior of the vehicle corresponds to the already described four-axle steering system with optimal maneuverability. In addition, the Ackermann intersection point can also be located before the foremost or behind the rearmost vehicle axle whereby a special cornering behavior can be implemented.

For clarification, let it also be mentioned that the described steering method also makes possible and comprises the adjustment of a so-called parallel mode where the wheel axles are adjusted so as to run in parallel. In other words, they meet in the infinity, thus constituting a special case within the method.

The two-wheel steering system also constitutes a special case within the four-wheel steering mode in which adjustment of the intersection point can be optimally adapted to the existing driving situation and the requirements thereof on the stability of the steering behavior and the maneuverability.

In a first preferred embodiment of the invention, it is provided that the vehicle commands at least two steering modes wherein one steering mode is a two-wheel steering mode where the wheel axles of at least one vehicle axle, if a vehicle having more than two axles is concerned, all axles except one axle are at least approximately fixed in straight arrangement and the Ackermann intersection pont is at least approximately on at least one vehicle axle.

“Approximately fixed” means that, under certain circumstances, it is possible that the wheel axles can perform a small angular movement even in fixed state. This can be attributed in the practice to a limited rigidity of the fixing and constitutes an undesired effect, but can also be created by a consciously allowed deflectability of the wheel axles by a few degrees or by fractions of a degree. It only is of the essence here that the possible angular deflection of the fixed axles be smaller by a multiple than the maximum deflection thereof in an unfixed state. Thereby clearly results to a great extent the steering behavior or a classic knuckle front axle steering system in which the Ackermann intersection point is on the rear vehicle axle.

The first embodiment further provides that at least one other mode be a four-wheel steering mode in which the Ackermann intersection point is not at least approximately on a vehicle axle and wherein an operator or a selector device chooses one suitable steering mode from the steering modes.

According to this embodiment, since at least two separate steering modes are provided of which one comes at least very close to the behavior of a classic front-axle knuckle steering system, an operator or also an automatic selector device can, when needed, easily select the modes in order to adjust one steering behavior that is most precisely known and trusted by the operator. On the other hand, if a greater maneuverability is desired at least one four-wheel steering mode can be selected.

There can obviously be also provided, when needed, several separately selectable four-wheel steering modes with different positions of the Ackermann intersection point on the vehicle longitudinal axis which the operator can purposefully select. By way of the inventive method, for an arbitrary number of the steering modes, there is needed together with a relatively easy switch for control of the steering device only one equally large number of switch positions of a selector element and of readable value memories.

In case of a plurality of switch positions having been provided or also in case of a continuous adjustability of the selector elements, the operator can choose, as needed, one Ackermann intersection point deemed optimal and thus adjust a driving behavior between a pure two-wheel steering system—optionally a front-wheel or rear-wheel steering system, a four-wheel steering system with optimal maneuverability or any intermediate values. In a conventional steering system, as a rule, at most one change between two steering modes is possible in which case either for both steering modes a compromise is reached regarding the sliding of the wheels upon the ground or the steering system is optimized for one steering mode, there occurring in the other steering mode an accordingly strong sliding.

When the position of the Ackermann intersection point, according to a second embodiment, is manually chosen by an operator, this ensures to the operator an optimal control over the steering behavior and prevents that the vehicle, due to an adjustment of the Ackermann intersection point unexpected by the operator, reacts to a steering error differently from what he foresees.

However, when the position of the Ackermann intersection point is chosen by a selector device at least in a four-wheel mode depending at least on a selection parameter of the Ackermann intersection point, this opens the possibility of an automatic or semi-automatic adaptation of the position of the Ackermann intersection point and thus of the steering behavior.

In case of a quite complicated problem, such as under a plurality or a theoretically unlimited plurality of different steering system adjustments, to select one that is actually adequate or entirely optimal is a decidedly desirable relief of the operator in this connection. This does not rule out that the operator, when needed, presets a manual adjustment having first to abandon an adjustment proposed by the selector and control device before it becomes effective and/or the selector and control device limits the selectable area.

In a first development in this connection, at least one selection parameter of the Ackermann intersection point is the basic value that determines the position of the Ackermann intersection point when the vehicle is stopped. The basic value can be automatically selected, for example, manually by a selector element with a plurality of detent steps, by a continuously adjustable selector element, by a direct input, but also according to other parameters.

The setting of the basic value makes it possible for the operator to have very precise control over the steering properties of his vehicle. Insofar as no other parameters for adjustment of the Ackermann intersection point are used, such as described herebelow by way of example, the steering behavior of the vehicle at constant basic value extensively corresponds to that of a conventional steering system and the method is similar to that extent to the properly described manual adjustment by the operator of the position of the Ackermann intersection point.

Alternatively or in addition, at least one selector parameter of the Ackermann intersection point can be the speed of the vehicle. This can be of special advantage both with regard to a steering behavior intuitively felt by the operator and in relation to as great a possible safety.

For example, it can be suitable for a vehicle that operates in a warehouse shed to use at especially low speeds, a nearly pure rear-axle steering system so as to be able to align on narrowest space a load fork upon a pallet located in the high bay warehouse. At high speeds, it is increasingly convenient to move the Ackermann intersection point in direction to a four-wheel steering system so as to achieve a good total maneuverability of the vehicle. At still higher speeds, the four-wheel steering system protects against certain dangers regarding the controllability of the vehicle by the operator. Hence, when exceeding a speed limit value, the Ackermann intersection point can be automatically moved in direction to a two-wheel steering system.

Since the operator is also accustomed to a change of the steering behavior with increasing speed from vehicles with conventional steering system, for example, a turn increasing with constant steering angle, a continuous or also a sufficiently finally stepped displacement of the Ackermann intersection point according to the speed is for him intuitively foreseeable or at least controllable in a short time. The reciprocal effect between the vehicle speed and the position of the Ackermann intersection point can, at the same time, be differently established according to vehicle and case of application. At the same time, it is also naturally conceivable to select among several different sets of such localizations and, for example, a manual selection of a set by the operator. The change of position of the Ackermann intersection point as the speed increases can thus be differently established in a warehouse mode and a construction site mode.

One development of the invention especially convenient for many cases consists of the selector device moves the position of the Ackermann intersection point increasingly in direction to a rear axle in predominant travel direction of the vehicle while the vehicle speed rises. In a two-axle vehicle, this clearly means that starting from a basic value for the position of the Ackermann intersection point at a vehicle speed with the value zero, which can be firmly preset or selected by the operator, the Ackermann intersection point with increasing travel speed moves in direction to the rear-axle of the vehicle with which increasingly results the steering behavior of a conventional front-axle knuckle steering system.

It can be provided, for example, that from a lower limit speed of 5 Km/h, the Ackermann intersection point continuously moves in direction to the rear axle reaching it at a driving speed of 45 Km/h, starting from a basic value lying in the middle point between the front axle and the rear axle, as the vehicle speed increases.

It particularly occurs in construction site vehicles and shunting vehicles that the travel direction often changes and both travel directions share in nearly equal portions in the total driving operation. For those vehicles, it is of special advantage that the selector device moves the position of the Ackermann intersection point as the vehicle speed increasingly rises in a direction to a rear axle in travel direction of the vehicle. In this way, the symmetrical driving behavior results for both travel directions. Obviously, this base idea can also be conveniently used in combination with the other developments of the method by using in relation to the travel direction, instead of axle indications fixed to the vehicle, define axle indications.

Another improvement of the steering behavior can be achieved within the inventive method when a selection parameter of the Ackermann intersection point is a maneuverability standard which establishes to what extent other selection parameters of the Ackermann intersection point should be taken into account by the selector device for the displacement of Ackermann intersection point.

It is conceivable, for example, that another selection parameter of the Ackermann intersection point be the friction value of the ground which is determined via a sensor. Depending on the adjusted basic value and the momentary vehicle speed, the selector device then quickly moves the Ackermann intersection point in direction to the rear axle the more slipperier the ground is since, in this case, an unstable steering behavior is specially dangerous at high speeds. By the slipperiness depends not only on the determined friction value of the ground but also, for example, on the tire set. Even under unfavorable conditions an experienced operator still can reliably control and without problem make use of the advantages of a relatively distinct four-wheel steering system whereas an inexperienced operator, with the same adjustment of the Ackermann intersection point, can get into dangerous situations.

With the aid of the maneuverability standard value, an experienced operator, who moves a vehicle with snow chains or spiked tires, can adjust the evaluation of the selection parameters of the Ackermann intersection point to zero or to a low value whereupon the selector device, even in case of a very low sensor value determined for the friction value of the ground, moves the Ackermann intersection point tendentially in direction of the middle point between the vehicle axles, thus adjusting a high maneuverability of the vehicle.

An inexperienced operator, who has to move the vehicle upon the same ground with low friction value without snow chains or spiked tires, will adjust the maneuverability standard value so that the evaluation of the selection parameter of the Ackermann intersection point “friction value of the ground” is high whereby the Ackermann intersection point is moved tendentially in direction to the rear axle whereby results a better stability of the steering behavior of the vehicle.

The maneuverability standard value, at the same time, can commonly apply to precisely one or more selection parameters of the Ackermann intersection point. Likewise, it is obviously possible to provide several different maneuverability standard values which respectively establish the evaluation of different selection parameters of the Ackermann intersection point.

An easily definable and yet extraordinarily advantageous maneuverability standard value is the one that determines the evaluation of the vehicle speed for defining the position of the Ackermann intersection point. In the simplest case, the maneuverability standard value can consist in the issuance of a virtual vehicle speed signal to the selector device of the Ackermann intersection point. If the maneuverability standard value is adjusted to a high value, the rear vehicle speed can be multiplied, for example, by a factor of 0.5 whereas the factor in a low value can amount to 2.0, for example. In this manner with otherwise equal adjustments, the vehicle speed is, to a greater or lesser extent, taken into account when determining the Ackermann intersection point to be adjusted. Together with a multiplication, additions or subtractions are also obviously possible for determining the virtual vehicle speed, the same as extensive mathematical linkages or value tables and characteristic fields.

When an operator manually adjusts the maneuverability standard value, this has the advantage of a good, direct and exact control of the driving behavior by an experienced and skilled operator.

However, since most operator would probably be overburdened with a possibility of adjustment operating with such complexity, in another design of the inventive method it is provided that on the basis of outer conditions and/or prior driving maneuvers, a selector and a control device automatically selects or adapts the maneuverability standard value. The operator is thus relieved from this problem.

The invention also concerns a device for a steering system adjustment and a steering system of vehicle wheels with a knuckle steering system, the same as with a plurality of steerable vehicle axles with which, starting from a steering angle of a steering wheel, steering actuators can be operated by steering devices by means of the wheels being adjusted to the vehicle steering system taking into account the steering angle. All extensions of the axles of the wheels meeting for approximately arbitrary steering angles, at least near an Ackermann point where the extensions of the axles of all wheels, intersect to meet the Ackermann condition, especially for applying the method.

This device is characterized by a control and a selector device which is in signal connection with a selector element for manual input of the steering properties to be adjusted in the vehicle, which is connected with sensors for autonomously determining the steering properties to be adjusted, by way of a steering sensor, can be fed the adjustment of a vehicle steering wheel and which is designed so that, in accordance with the automatically detected and/or manually preset values, it adjusts the vehicle steering system and/or steers the vehicle so that the Ackermann intersection point can be moved along the vehicle longitudinal axis and/or the extension thereof within an area determined by the maximum steering angle of the wheel axles.

In an advantageous development of this device, it is provided that the sensors are designed for detecting the vehicle speed and the tractional capacity of the vehicle wheels or of the road.

Besides, the selector element can be designed for manual input regarding a maneuverability standard value so that an operator, eventually the driver of a fork lift truck, can manually preset, according to the precisely prevailing working situation, whether at the time the vehicle operates with very good steering properties for a comparatively quick forward motion or with very good steering properties regarding a shunting and lifting operation.

### BRIEF DESCRIPTION OF THE DRAWINGS

The invention will now be described, by way of example, with reference to an extensively abstracted chassis of a vehicle having two steerable axles and equipped with a device for applying the inventive method. In detail, the Figures show:

FIG. 1 is a chassis in a steering position in which the Ackermann intersection point is in the middle point between front axle and rear axle;

FIG. 2 is the same chassis in a steering position in which the Ackermann intersection point is moved in direction to the rear axle, and

FIG. 3 is the same chassis in a steering position in which the Ackermann intersection point is moved to the level of the rear axle.

### DETAILED DESCRIPTION OF THE INVENTION

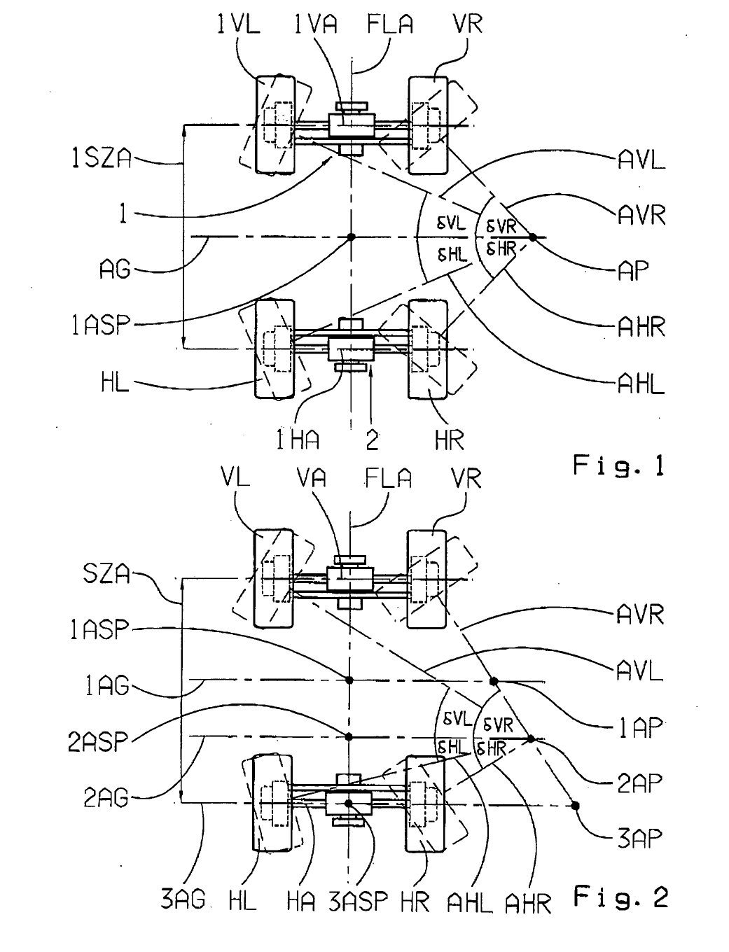

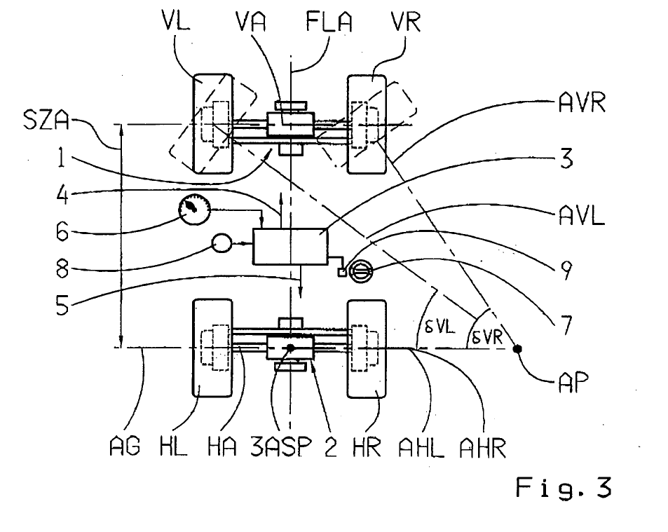

For the sake of clarity in FIGS. 1 to 3, the same or corresponding elements are each provided with the same reference numerals which are preceded by a number when needed for differentiation. To the extent that the description applies to all Figures, the preceding numbers of FIGS. 1 to 3 have been omitted. An element ASP, for example, is to be read in the description as element 1ASP in FIG. 1, as element 2ASP in FIG. 2 and as element 3ASP in FIG. 3.

In FIGS. 1 to 3, the extensively abstracted chassis of a vehicle is shown in top view in which each of the four wheels which, according to their position front left, front right, rear left and rear right, are designated with references VL, VR, HL and HR. The wheels VL, VR, HL and HR are each in straight alignment and, with the exception of the wheels 3HL and 3HR in FIG. 3, are additionally shown in a deviated position to which reference will be had herebelow insofar as this has not been expressly or differently specified.

Both front wheels VL and VR are coordinated with the front vehicle axle VA while the rear wheels HL and HR are coordinated with the rear vehicle axle HA. The steering kinematics of the axles VA and HA, respectively, is only indicated in FIGS. 1 to 3 and laid out so that the wheels VL, VR, HL and HR can be impacted with different strength. For example, they can consist of a single wheel steering system with separately controllable and adjustable actuators or be shaped in the manner of the Applicant's DE-10 2004 053 727.

Steering angles δVL, δVR, δHL and δHR of the wheels VL, VR, HL and HR, respectively, correspond to the angle between the extensions of wheel axles AVL, AVR, AHL and AHR coordinated with the wheels VL, VR, HL and HR, the same as a straight line parallel with the vehicle axles which can be, for example, an Ackermann straight line AG. The extensions of the wheel axles AVL, AVR, AHL and AHR meet for compliance with the Ackermann condition at an Ackermann point designated with AP. The Ackermann straight line AG cutting perpendicularly to a vehicle longitudinal axis FLA at the Ackermann point ASP. The steering behavior of the vehicle essentially depends here on the position of an Ackermann intersection point ASP on the vehicle longitudinal axis FLA.

In the position shown in FIG. 1, the Ackermann intersection point 1ASP is in the middle point of a track 1SZA between the axles 1VA and 1HA. Thereby results a driving behavior of the vehicle with a very small turning circle and an altogether great maneuverability, the vehicle tending, of course, to unstable steering behavior at high vehicle speeds.

In the position of the Ackermann intersection point 3ASP shown in FIG. 3, at the intersection point of the rear vehicle axle 3HA with the vehicle longitudinal axis 3FLA, the steering angles 3δHL and 3δHR necessarily amount to zero degrees. This corresponds to a pure front-axle knuckle steering system. The resulting driving behavior of the vehicle has a large turning circle compared to the vehicle according to FIG. 1 and an altogether lesser maneuverability, but the vehicle shows a clearly stabler behavior at high driving speeds.

In FIG. 2 is shown, together with the above described positions of the Ackermann intersection points 1ASP and 3ASP, an intermediate position of the Ackermann intersection point 2ASP. In relation to maneuverability, turning circle diameter and stability of the steering behavior at high speeds, the driving behavior represents a compromise between the above described properties.

In steering methods of the prior art, there is provided or possible at least only one position of the Ackermann intersection point ASP and upon a change of steering system kind, for example, between a two-wheel steering mode and a four-wheel steering mode, allowance must, therefore, be made mostly for a clear violation of the Ackermann condition and accordingly a relatively increased wear on the tires and chassis parts.

The central idea of the introduced method consists in that the position of the Ackermann intersection point can be freely adjusted without time spent at the workshop whereby different steering behaviors can be implemented on the same vehicle without prejudice to the Ackermann condition which results in inevitable sliding of the wheels VL, VR, HL, HR on the ground. The wheel axles or the extensions thereof AVL, AVR, AHL and AHR can be adjusted at the same time with a specifically desired angular deviation or allowance is knowingly made in certain situations for a certain steering angle error of the wheel axles.

According to the introduced method, an operator is now in position freely to moved the Ackermann intersection point ASP within a wide scope.

In developments of the method, the adjustment of a selector device can be made entirely automatic or, starting from a basic value, previously adjusted by the operator. Altogether, it is favorable if the Ackermann intersection point ASP is increasingly adjusted in direction to the rear vehicle axle HA as the vehicle speed increases.

If the vehicle moves in reverse not only rarely, it is convenient to select the vehicle axle VA or VH located precisely behind during the momentary driving direction instead of the rear axle HA defined fixed to the vehicle.

If the operator can, in addition, input a maneuverability standard value, he can take control of the evaluation of the speed and/or of additional different control parameters for the displacement of the Ackermann intersection point.

The inventive method altogether makes a formerly unknown abundance of possibilities, easily and comfortably to adjust the steering behavior of a vehicle and, at the same time, especially to prevent violation of the Ackermann condition caused by sliding of the tires on the ground.

As made clear in FIG. 3, the device for applying the introduced method has a selector and control device 3 which is in signal connection with a selector element 6 or manual input of the steering properties to be adjusted in the vehicle. Besides, the selector and control device 3 is connected with sensors 8 for autonomously determining, via sensor lines, the steering properties to be adjusted in the vehicle according to the operating conditions that actually prevail. Besides, the control and selector device 3 receives information concerning the steering position of a vehicle steering wheel 7 from a steering angle sensor 9.

The selector and control device 3 is now further designed in a manner such that, depending on the automatically detected and/or manually preset values, it adjusts the steering system of the vehicle or steers the vehicle so that the Ackermann intersection point ASP is movable along the vehicle longitudinal axis FLA and/or the extension thereof within an area determined by the maximum steering angle of the wheel axles VA, HA.

To achieve this as optimally as possible, the sensors 8 are preferably designed to detect the vehicle speed and/or the tractional capacity of the vehicle wheels or of the road. Regarding the selector element 6, it is provided in addition that it be designed for manual input relative to a maneuverability standard value.

With the aid of the entered or automatically determined parameters and related control and regulation program, the selector and control device 3 produces the steering actuators on the steering device 1 and 2 on the front axle VA and the rear axle HA of the vehicle control signals for which are delivered to these via control lines 4 and 5. On one hand, the control signals for the steering actuators take into account the determined or manually preset steering or maneuverability adjustment, the same as obviously the steering angle standard of the operator, via the vehicle steering wheel 7.

### REFERENCE NUMERALS

1 steering device with steering actuators on the front axle
2 steering device with steering actuators on the rear axle
3 selector and control device
4 control line
5 control line
6 selector element
7 steering wheel
8 sensors
9 steering angle sensor
VL wheel of the vehicle, front left
VR wheel of the vehicle front right
HL wheel of the vehicle, rear left
HR wheel of the vehicle, rear right
VA front vehicle axle
HA rear vehicle axle
SZA track between the axles VA and HA
AVL extension of the wheel axle coordinated with the wheel VL
AVR extension of the wheel axle coordinated with the wheel VR
AHL extension of the wheel axle coordinated with the wheel HL
AHR extension of the wheel axle coordinated with the wheel HR
δVL steering angle of the wheel VL
δVR steering angle of the wheel VR
δHL steering angle of the wheel HL
δHR steering angle of the wheel HR
FLA vehicle longitudinal axis
AP Ackermann point
AG Ackermann straight line
ASP Ackermann intersection point

1-15. (canceled)

16. A method of adjusting wheels (VL, VR, HL, HR) with a steering system of a vehicle having a knuckle steering system, the method comprising the steps of:
adjusting the wheels (VL, VR, HL, HR) by means of steering actuators, which are operated by a steering device (1,2) taking into account a steering angle of a steering wheel (7), the wheels (VL, VR, HL, HR) each having an axis with an extension (AVL, AVR, AHL, AHR) perpendicular to rotation of the wheels (VL, VR, HL, HR);
directing the extensions (AVL, AVR, AHL, AHR) of each of the axis of the wheels (VL, VR, HL, HR) to meet at an Ackermann point (AP) and satisfy an Ackermann condition, each of the extensions (AVL, AVR, AHL, AHR) forming a steering angle (δVL, δVR, δHL, δHR) with an Ackermann straight line (AG), which extends perpendicular to a vehicle longitudinal axis (FLA);
adjusting the steering system by one of an operator or a selector and control device (3), such that an Ackermann intersection point (ASP) is displaced along at least one of the vehicle longitudinal axis (FLA) and an extension of the vehicle longitudinal axis (FLA) within an area determined by a maximum steering angle of vehicle axles (VA, HA), the Ackermann intersection point (ASP) being a point at which at least the vehicle longitudinal axis (FLA) or the extension thereof and the Ackermann straight line (AG) intersect at a right angle, the Ackermann straight line (AG) being a straight line which intersects the vehicle longitudinal axis (FLA) at right angle and leads through the Ackermann point (AP).

17. The method according to claim 16, further comprising the step of utilizing at least two steering modes, a first steering mode being a two-wheel steering mode in which the wheels (VL, VR, HL, HR) are at least approximately fixed in straight position, and the Ackermann intersection point (ASP) is at least approximately upon at least one vehicle axle (VA, HA), the second mode being a four-wheel steering mode in which the Ackermann intersection point (ASP) does not lie on the at least one vehicle axle (VA, HA), the operator or selector device choosing from the first and second steering modes, an adequate steering mode.

18. The method according to claim 16, further comprising the step of manually select a position of the Ackermann intersection point (ASP) with an operator.

19. The method according to claim 17, further comprising the step of taking into account at least one selection parameter of the Ackermann intersection point during selecting, with the selector and control device (3), the position of the Ackermann intersection point (ASP) while in at least the four-wheel mode.

20. The method according to claim 17, further comprising the step of determining the Ackermann intersection point (ASP), when the vehicle is stationary, with at least one selector parameter of the Ackermann intersection point as a basic value.

21. The method according to claim 19, further comprising the step of utilizing speed of the vehicle as at least one selector parameter of the Ackermann intersection point.

22. The method according to claim 21, further comprising the step the moving the Ackermann intersection point (ASP) with the selector device, as the vehicle speed increases, in a direction toward a rear vehicle axle (HA).

23. The method according to claim 21, further comprising the step of moving the position of the Ackermann intersection point (ASP) with the selector and control device (3), as the vehicle speed increases, in direction to a rear vehicle axle (VA, HA) in travel direction of the vehicle.

24. The method according to claim 19, further comprising the step of utilizing a maneuverability standard value as a selector parameter of the Ackermann intersection point, the maneuverability standard value establishing to what extent other parameters must be taken into account by the selector and control device (3) for moving the Ackermann intersection point (ASP).

25. The method according to claim 24, further comprising the step of determines an appraisal of the vehicle speed for determining the position of the Ackermann intersection point (ASP) with the maneuverability standard value.

26. The method according to claim 24, further comprising the step of an manually adjusting the maneuverability standard value with the operator.

27. The method according to claim 24, further comprising the step of utilizing a selector and control device (3) to automatically select or adapt the maneuverability standard value on one of a basis of external conditions and prior driving maneuvers.

28. A method of adjusting wheels (VL, VR, HL, HR) with a steering system of a vehicle having a knuckle steering system, the method comprising the steps of:
adjusting the wheels (VL, VR, HL, HR) by means of steering actuators, which are operated by a steering device (1,2) taking into account a steering angle of a steering wheel (7), the wheels (VL, VR, HL, HR) each having an axis with an extension (AVL, AVR, AHL, AHR) perpendicular to rotation of the wheels (VL, VR, HL, HR);
directing the extensions (AVL, AVR, AHL, AHR) of each of the axis of the wheels (VL, VR, HL, HR) to meet at an Ackermann point (AP) and satisfy an Ackermann condition, each of the extensions (AVL, AVR, AHL, AHR) forming a steering angle (δVL, δVR, δHL, δHR) with an Ackermann straight line (AG), which extends perpendicular to a vehicle longitudinal axis (FLA);
connecting one of a selector and control device (3) to a selector element (6) to transfer signals for manually inputting steering properties to be adjusted in the vehicle, the selector and control device (3) being connected with sensors (8) for autonomously determining steering properties to be adjusted;
delivering to the selector and control device (3), a position of a vehicle steering wheel (7) by means of a steering sensor (9), such that depending on at least the automatically detected and manually preset values, the selector and control device (3) adjusts at least the vehicle steering system or steers the vehicle such that the Ackermann intersection point (ASP) is movable along at least one of the vehicle longitudinal axis (FLA) and the extension of the vehicle longitudinal axis within an area determined by the maximum steering angle of the axles (VA, HA).

29. The method according to claim 28, further comprising the step of designing the sensors (8) to detect vehicle speed and tractional capacity of one of the vehicle wheels or of a road.

30. The method according to claim 28, further comprising the step of designing the selector element (6) for manual input regarding a maneuverability standard value.
